(19) United States
(12) Patent Application Publication
(10) Pub. No.: US 2004/0177233 A1
(43) Pub. Date: Sep. 9, 2004

(54) Method and apparatus for executing stack-based programs

(76) Inventors: Maciej Kubiczek, Middlesex (GB); Christopher Robert Turner, Middlesex (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/482,487

(22) PCT Filed: Jun. 24, 2002
(86) PCT No.: PCT/GB02/02889

(30) Foreign Application Priority Data
Jul. 3, 2001 (GB) 0116277.5

(51) Int. Cl. G06F 9/30

(52) U.S. Cl. 712/202; 712/209; 712/227

(57) ABSTRACT

A method of executing a stack-based program using a processor having a register-based architecture, the processor having means for simulating a stack using a subset of its registers such that the processor may operate in a simulated stack-based mode as well as a register-based mode. The method comprises the steps of fetching stack-based instructions from a program memory, translating individual stack-based instructions or sequences of stack-based instructions into register-based instructions, and including in at least certain of the translated instructions an indication that these instructions are to be executed using the simulated stack-based mode. Translated instructions, including said indication, are executed using the simulated stack-based mode, and other translated instructions are executed using the register-based mode.

### FIELD OF THE INVENTION

The present invention relates to a method and apparatus for executing stack-based programs and is applicable in particular, though not necessarily, to a method and apparatus for executing Java Virtual Machine programs using a RISC processor.

### BACKGROUND OF THE INVENTION

The JAVA™ programming language was developed by Sun Microsystems™ as a means of creating highly compact program code which can be executed on virtually any processing system. Whilst Java programs are translated into programs for a so-called Java Virtual Machine (JVM), and since the JVM can be implemented on any processor system, JAVA is effectively system independent.

JVM is an example of a stack-based instruction set architecture—other examples of stack based architectures are the MULTOS virtual machine and the Visual Basic virtual machine. Stack-based languages are designed to operate on processors (real or virtual) which temporarily store data, during the execution of a program instruction (or series of instructions), in a stack, i.e. which utilise a stack-based architecture. Data is added to or removed from the top of the stack as appropriate. The location of stack data to be acted upon by an instruction, or the stack location at which the result is to be stored, is implicit in the instruction. For example, the JVM instruction “iadd” requires the removal of the top two elements of the stack, and their replacement with the result of the addition on the top of the stack. Stack-based architectures are therefore fundamentally different from the register-based architectures of most modern microprocessors and which use a large bank of registers to temporarily store data during execution of program instructions. An example of an instruction used belonging to a register based programming language is “add rx,ry,rz”, which requires that the contents of registers ry and rz be added together, and the result stored in register rx. It will be apparent that the stack-based language architecture results in a much more compact program code than the register-based architecture.

This said, a JVM is more often than not implemented on a microprocessor having a register-based architecture. This requires the translation (static or dynamic) of the JVM program to be executed, into the register-based programming language used by the microprocessor. Broadly speaking, two translation strategies have been adopted: software-only solutions and hardware accelerators.

Software acceleration of Java involves the use of Just In Time (JIT) techniques. In the JIT approach, the machine-independent Java bytecodes are translated before execution into the native machine instructions of the host platform. JIT techniques (and their derivatives, such as HotSpot™ from Sun Microsystems) have proven to be useful on large platforms (e.g. the Intel Pentium™ processor and its equivalents) where processing power and memory are available in abundance. In embedded systems (using for example RISC processors such as the ARM™ and ARC™ processor families), the use of JIT technology suffers from several drawbacks:

The JIT compiler has to be a part of the application run-time. This component is typically quite complex (it is after all a compiler back-end) and requires considerable resources, which are often not available in low-cost embedded systems.

The use of highly optimizing JIT schemes may introduce security holes into the virtual machine. This is unacceptable in security-conscious applications (such as smartcards).

JIT compiled code suffers from what is termed code bloat. This means that the size of the native code produced by the JIT compiler is often up to five times larger than the size of the original JVM bytecodes.

Because the JIT phase is time consuming, larger Java applications suffer from noticeable (and annoying) start-up times. The processor cycles used to JIT compile Java classes use up valuable battery power, and this fact may exclude this implementation approach from many battery-powered application areas.

RISC processors therefore tend to make use of a hardware coprocessor module which adds an extra pipeline stage to the main processor, and which converts stack-based instructions “on-the-fly” into native register-based program instructions. These coprocessors are typically quite large in terms of their component count (duplicating much of the hardware components contained in the RISC processor, such as the program fetch logic) and are comparable in size to the main processor itself. This of course adds to the cost of the processor. Coprocessors also tend to introduce a degree of inflexibility, only being operable with one particular “flavour” of JVM.

In architectures which make use of a hardware coprocessor, the coprocessor is activated by means of executing a mode switch instruction contained within a program, and which switches the processor into a special mode (“Java mode” in the case of Java accelerators). In this mode, the main processor fetch unit is disabled, and replaced by the “stack mode” fetch unit. This fetch unit retrieves a stack-based instruction (e.g. JVM instruction) from the program memory, translates it into a sequence of native instructions (e.g. RISC) of the main processor, and passes the translated sequence of instructions down the RISC processor pipeline.

A stack-based program will typically contain (short) sequences of code which may be efficiently translated into one line or a reduced number of lines of the register-based program code, i.e. as opposed to translating the sequences line by line. The process of identifying and translating such sequences may be carried out by the program loader (typically software executed by the register processor) which loads the stack-based code into the program memory prior to executing the program. The result will be a sequence of code which contains both stack-based code and register-based code interleaved. Special instruction can be included to identify the former. When the coprocessor architecture is used, the coprocessor is switched on when a block of stack based instructions is to be executed and is switched off when a block of register-based instructions is to be executed. However, as each mode switch can consume many clock cycles, the advantages obtained by identifying and translating such code blocks are to a great extent negated because the overhead of the mode switch operation is greater than the savings provided by using an optimised version of the code.

### STATEMENT OF THE INVENTION

According to a first aspect of the present invention there is provided a method of executing a stack-based program using a processor having a register-based architecture, the processor having means for simulating a stack using a subset of its registers such that the processor may operate in a stack-based mode as well as a register-based mode, the method comprising the steps of:

fetching stack-based instructions from a program memory;

translating individual stack-based instructions or sequences of stack-based instructions into register-based instructions, and including in at least certain of the translated instructions an indication that these instructions are to be executed using the stack-based mode;

executing translated instructions, including said indication, using the stack-based mode, and executing other translated instructions using the register-based mode.

Embodiments of the present invention offer the significant advantage that the hardware or software required to perform the translation of stack-based instructions to register-based instructions is relatively simple. This results from the implementation of a stack in the register-based processor which greatly simplifies the translation process.

Preferably, the method comprises identifying sequences of instructions fetched from the program memory which can be translated into one or a reduced number of register-based instructions. Each identified sequence is translated into one or a reduced number of register-based instructions, whilst each stack-based instruction which does not belong to one of said identified sequences is translated into an equivalent register based instruction. Typically, an instruction resulting from the translation of a sequence of stack-based instructions will not contain said indication as that translated instruction can be efficiently executed using the register-based architecture. On the other hand, an instruction resulting from the translation of a single stack-based instruction will typically contain said indication as that instruction can be efficiently executed using the stack.

Preferably, the translation of stack-based instructions fetched from the program memory is carried prior to execution of the program. The translated program is stored temporarily in memory. As the code expansion resulting from the translation is less than that resulting from the use of a hardware coprocessor, the memory requirements are not excessive. Alternatively, the translation of stack-based instructions fetched from the program memory may be carried out on-the-fly, i.e. immediately prior to the execution of the instructions. This avoids the need for a large memory to store expanded register-based instructions.

In one embodiment of the invention, the stack based-program is a JVM program, and the processor having a register-based architecture is a RISC processor such that the register-based instructions are RISC instructions. However it will be appreciated that the invention may also be applied to other stack-based programming languages and other processor architectures.

Preferably, said indication that a translated instruction is to be executed using the stack is provided by the inclusion, in a register address space of the instruction, of a dummy or phantom register address (which may correspond to a non-existent or unused register). If a phantom register address is detected, that address is replaced in the instruction by an address of a register in the stack. A counter register of the processor maintains a pointer to the top of the stack

Preferably, the means for simulating a stack comprises a stack counter which points to the top of the stack.

According to a second aspect of the present invention there is provided apparatus for executing a stack-based program, the apparatus comprising:

a set of registers;

means for utilising a subset of said registers to provide a stack so that the processor can operate in a stack-based mode as well as a register-based mode;

means for fetching stack-based instructions from a program memory and for translating individual fetched instructions, or sequences of fetched instructions, into register-based instructions, and for including in at least certain of the translated instructions an indication that those instructions are to be executed using the stack-based mode; and

means for executing translated instructions including said indication, using the stack-based mode, and executing other translated instructions using the register-based mode.

Preferably, said indication is one of a number of phantom register addresses, and said means for utilising a subset of said registers to provide a stack comprises means for recognising a phantom register address in a translated instruction, and means for replacing that phantom address with the address of a register in the stack. More preferably, a counter register is provided to maintain a pointer to the top of the stack. Means is provided for incrementing or decrementing the pointer held by the counter register following the processing of a translated instruction containing an indication that the instruction is to be executed using the stack-based mode. The pointer is incremented or decremented by an amount depending upon the phantom register address.

### BRIEF DESCRIPTION OF THE DRAWINGS

FIG. 1 illustrates schematically a modified RISC processor system for executing a JVM program;

FIG. 2 illustrates schematically the RISC processor system of FIG. 1 in more detail;

FIG. 3 illustrates in more detail register address adaption circuitry of the processor system of FIG. 1; and

FIG. 4 is a flow diagram illustrating a method of executing a JVM program on a RISC processor system.

### DETAILED DESCRIPTION OF A PREFERRED EMBODIMENT

The embodiment of the invention which will now be described requires a modification (or rather extension) to the conventional RISC architecture. It consists in particular of assigning a part (typically 16 registers, r0 to r15) of the general-purpose register bank of the RISC processor to act as a stack, and adding new instructions to the processor which allow stack operations to be performed using the designated part of the register bank The new RISC instructions are differentiated from existing instructions by the inclusion therein of suitable indicators (nb. the instructions are not new per se, rather, by the inclusion of the indicators, the instructions can be interpreted in a new way). The extended RISC instruction set is referred to here as RISC+ and enables the effective mapping of the JVM stacks onto the register bank.

### General Discussion

The technique of efficiently executing stack-based programs on such an extended RISC architecture uses the following modules arranged at the input side of the processor:

A buffer (BUF) which holds a block of stack-based instructions. The buffer may be implemented in hardware or software.

A circuit or software module (TR1) which replaces (translates) a single stack-based instruction with one or more native RISC+ instructions.

A circuit or software module (TR2), which compares a sequence of stack-based instructions with a collection of patterns stored in the module, and replaces (translates) any matching stack-based sequence with a one or more native RISC+ instructions which are also stored in the module.

A circuit or software module (DET) which detects that no pattern stored in the module corresponds to the current input sequence, and generates a control signal which activates the module TR1 to replace (translate) each individual stack-based instruction in the sequence with its corresponding native RISC+ instruction.

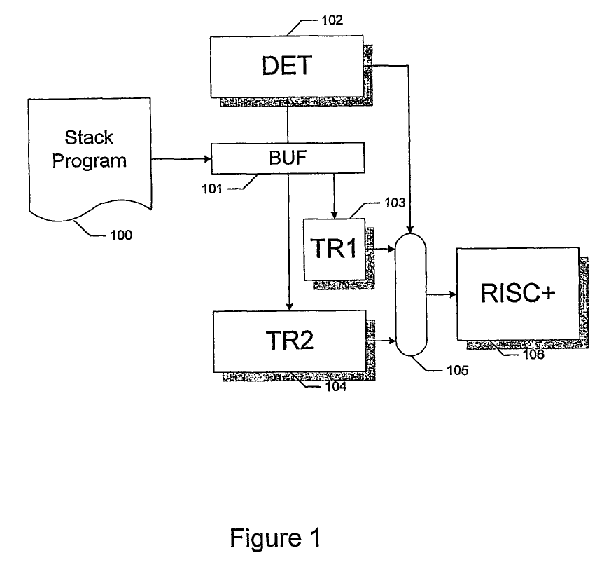

FIG. 1 shows the arrangement of these modules to implement a technique for efficiently executing stack-based programs 100 on an augmented RISC architecture 106. The stream of stack-based instructions is fed into the BUF module 101. The contents of the buffer are examined by the DET module 102, which determines whether the instruction code sequence matches any of the patterns stored in the TR2 module 104. If no match is detected, the instructions in the BUF module are translated individually into native RISC+ instructions by the TR1 module 103 and are passed to the fetch unit of the processor. (From the following discussion, it will be clear that the translation process carried out by TR1 103 is relatively simple as the translated instructions preserve much of the stack related information contained in the stack-based instructions. Translation can be carried out using a simple look-up table) If a match is detected, the output sequence of native RISC+ instructions, stored in TR2 104, is passed to the fetch unit 105 of the processor.

By way of example, consider the following sequence of stack-based (JVM) instructions representing the simple operation x=x+y:

| | |
|---|---|
| iload x | ;Load local variable x onto the stack |
| iload y | ;Load local variable y onto the stack |
| iadd | ;Add top stack elements and replace with result |
| istore x | ;Store result in local variable x |

The TR1 module could translate individual JVM instructions into respective native RISC+ instructions. An example translation scheme for the instructions in the above fragment is shown below (where rn identifies a register of the simulated stack when 0<=n=15):

| | | |
|---|---|---|
| iload x | => | mov r0+, rx |
| iload y | => | mov r0+, ry |
| iadd | => | add r2, r1−, r2 |
| istore x | => | mov rx, r1− |

However, a pattern consisting of two loads from local variables, followed by an arithmetic operation, followed by a store to a local variable, is stored in the TR2 module. The DET module detects this pattern in the input block, inhibits module TR1, and causes TR2 to output an optimised RISC instruction in place of the instructions which would be individually translated by TR1. This optimised RISC instruction is:

add rx,rx,ry.

In order to implement stack-like operations within the existing RISC instruction set, some means must be provided to control the operation of a stack counter control circuit. For this purpose, the concept of a phantom register is introduced. This is a register number which is an alias for stack register number 0 or 1, and is used by the register mapping mechanism to specify how the stack counter is to change after performing the mapping. Three phantom registers are required to implement a stack-based instruction set extension, called r0+, r1− and r1−−(these phantom registers are identified by register addresses corresponding to three unused registers of the 64 available registers). The translation circuits TR1 and TR2 include phantom register addresses in translated instructions when appropriate. Whenever the register mapping circuit detects one of the phantom register addresses in an instruction, it:

a) substitutes 0 for r0+, and 1 for r1− and r1−−, and

b) sends a control signal to increment a 4-bit stack counter (SC) by one for r0+, decrement SC by one for r1− and decrement SC by two for r1−−.

If none of the three operands (A,B or C) is a phantom register address, the register mapping circuit sends a control signal to leave SC unchanged.

Some examples of implementing stack-based instructions using the augmented RISC instruction set are shown below. With the register mapping circuit enabled, the first “empty” slot on the stack is mapped via register number 0, the top of stack element on the stack via register number 1, the second stack element via register number 2 and so on.

To add the two top stack elements and replace them with their sum:

add r2, r1−,r2.

The second stack element is replaced with the sum of the top of stack element and the second stack element. Since phantom register r1− is used, the stack counter register will be decremented by 1 after executing the instruction. This will cause the old second stack element to become the new top of stack element when the subsequent instruction is executed.

To duplicate the top stack element:

mov r0+,r1

The first empty slot on the stack is filled with the top stack element. Since phantom register r0+ is used, the stack counter register will be incremented by 1 after executing the instruction. This will cause the old first empty slot to become the new top of stack element when the subsequent instruction is executed.

To load a constant on top of the stack:

mov r0+,#13.

### DETAILED EXAMPLE

As an example of a preferred embodiment of the technique, translation schemes TR1 and TR2 for an augmented version of ARC™ RISC core and an integer subset of JVM instructions will now be described.

Translation Scheme TR1

As described above, this module (implemented in hardware or software) translates a JVM bytecode into a sequence of one or more RISC+ instructions. The following description lists the mnemonic of the JVM bytecode to the left, and its corresponding RISC+ translation to the right of the arrow (=>). A unified data/local variable stack is assumed. The identifier r<x> refers to the location of variable <x> within the stack (relative to the top of stack).

a. Push a constant on stack

| | | |
|---|---|---|
| aconst_null | => | mov r0+, 0 |
| iconst_m1 | => | mov r0+, −1 |
| iconst_0 | => | mov r0+, 0 |
| iconst_1 | => | mov r0+, 1 |
| iconst_2 | => | mov r0+, 2 |
| iconst_3 | => | mov r0+, 3 |
| iconst_4 | => | mov r0+, 4 |
| iconst_5 | => | mov r0+, 5 |
| bipush n | => | mov r0+, n |
| sipush n | => | mov r0+, n |

b. Load a local variable on the stack

| | | |
|---|---|---|
| iload <x> | => | mov r0+, r<x> |
| iload_0 | => | mov r0+, r<0> |
| iload_1 | => | mov r0+, r<1> |
| iload_2 | => | mov r0+, r<2> |
| iload_3 | => | mov r0+, r<3> |

c. Store a value from the stack into a local variable

| | | |
|---|---|---|
| istore <x> | => | mov r<x>, r1− |
| istore_0 | => | mov r<0>, r1− |
| istore_1 | => | mov r<1>, r1− |
| istore_2 | => | mov r<2>, r1− |
| istore_3 | => | mov r<3>, r1− |

d. Generic stack manipulation operations

| | | |
|---|---|---|
| nop | => | nop |
| pop | => | mov r1, r1− |
| pop2 | => | mov r1, r1− |
| | | mov r1, r1− |
| dup | => | mov r0+, r1 |
| swap | => | mov r0, r1 |
| | | mov r1, r2 |
| | | mov r2, r0 |
| dup_x1 | => | mov r0+, r2 |
| dup_x2 | => | mov r0, r1 |
| | | mov r1, r2 |
| | | mov r2, r3 |
| | | mov r3, r0+ |
| dup2 | => | mov r0+, r2 |
| | | mov r0+, r2 |
| dup2_x1 | => | mov r0+, r2 |
| | | mov r0+, r2 |
| | | mov r3, r5 |
| | | mov r4, r1 |
| | | mov r5, r2 |
| dup2_x2 | => | mov r0+, r2 |
| | | mov r0+, r2 |
| | | mov r3, r5 |
| | | mov r4, r6 |
| | | mov r5, r1 |
| | | mov r6, r2 |

e. Integer arithmetic and boolean

| | | |
|---|---|---|
| iadd | => | add r2, r2, r1− |
| isub | => | sub r2, r2, r1− |
| ineg | => | sub r1, 0, r1 |
| iinc <x>, n | => | add r<n>, r<n>, n |
| iand | => | and r2, r2, r1− |
| ior | => | or r2, r2, r1− |
| ixor | => | xor r2, r2, r1− |

Translation Scheme TR2

A partial definition of translation scheme TR2 is shown below. The name <bop> refers to any JVM binary integer operation code and <uop> refers to any JVM unary integer operation. The left hand side is the JVM sequence to be matched and the (optimised) RISC+ instruction equivalent is shown to the right of the arrow (=>).

a) Pattern 1

| | | |
|---|---|---|
| iload <x> | | |
| iload <y> | | |
| <bop> | | |
| istore <z> | => | <bop> r<z>, r<x>, r<y> |

b) Pattern 2

| | | |
|---|---|---|
| iload <x> | | |
| iload <y> | | |
| <bop> | => | <bop> r0+, r<x>, r<y> |

c) Pattern 3

| | | |
|---|---|---|
| iload <x> | | |
| biconst n | | |
| <bop> | | |
| istore <y> | => | <bop> r<y>, r<x>, n |

d) Pattern 4

| | | |
|---|---|---|
| iload <x> | | |
| biconst n | | |
| <bop> | => | <bop> r0+, r<x>, n |

e) Pattern 5

| | | |
|---|---|---|
| iload <x> | | |
| <uop> | | |
| istore <x> | => | <uop> r<x>, r<x> |

f) Pattern 6

| | | |
|---|---|---|
| iload <x> | | |
| istore <y> | => | mov r<y>, r<x> |

g) Pattern 7

| | | |
|---|---|---|
| biconst n | | |
| istore x | => | mov r<x>, n |

The person of skill in the art will appreciate that many similar patterns may be produced.

In order to exploit the large register bank of the ARC and the powerful three-operand instructions, the present approach adopts a unified operand/local variable stack, mapped into the first 16 registers of the ARC register bank. Each JVM method definition in a class file contains information about the maximum number of elements used by the method on the data stack and the number of local variables and parameters required by the method. If the combined size of the stack, arguments and local variables is less than 16, all these elements can be stored in the register bank. For methods which require more data stack/stack frame data, the overflow is maintained in a memory-resident stack frame.

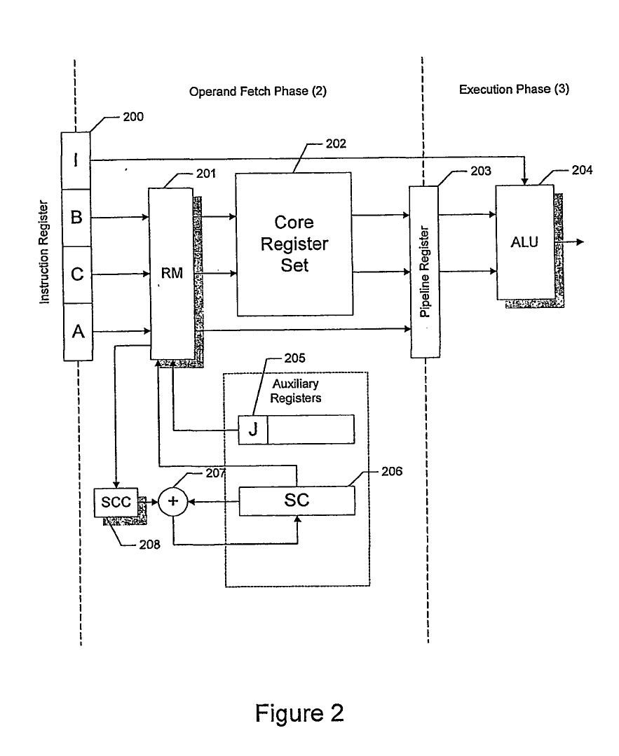

FIG. 2 shows the second and third stages of the ARC pipeline and the hardware modifications required to augment the processor (where an instruction register 200 holds 4 fields of information per instruction—an op-code field I, and three register address fields A, B, and C). The modifications consist of the following:

A register map circuit (RM) 201, which is described in detail later.

A J-mode bit 205 in either the PSW or in a separate auxiliary register. This enables/disables the operation of the RM circuit, in effect turning the augmented ARC+ mode on or off (during the execution of a typical JVM program, the J-mode bit is enabled).

A 4-bit stack counter (sc) register 206, allocated in the ARC auxiliary register bank, together with a 4-bit adder circuit 207 and a stack counter control circuit 208.

Three phantom registers allocated from the core register extension set 202. The registers are phantom, because they are used as aliases for other registers and provide additional information for the stack counter control circuit.

The purpose of the modifications is to allow the ARC processor to enable/disable the augmented instruction set (by setting the J bit in a register). With the J bit enabled, the ARC core register space (registers r0 . . . r63) 202 is partitioned into two groups:

Register numbers in the range 0 to 15 are mapped dynamically into “physical” registers r0 to r15 on the basis of the current value of the SC (stack counter) register 206. The mapping is simply the sum (modulo 15) of the register number and the value of SC 206.

Register numbers in the range 16 to 63 are mapped directly into the corresponding registers r16 to r63 (except for the phantom registers described below).

It will be apparent that the register mapping mechanism allows the first 16 registers of the ARC core to be treated as a “rotating” register file. In order to make this into a stack, some means of automatically incrementing and decrementing the SC register 206 has to be provided. In order to accomplish this, use is made of the extended core register range of the ARC processor (registers r32 through r63). Three phantom register numbers are assigned, called from now r0+, r1− and r1−−. The register mapping circuit detects the phantom register numbers, and:

Substitutes the phantom register number with r0 or r1 depending on the exact phantom register (r0 for r0+ and r1 for r1− and r1−−).

Generates an appropriate control signal for use by the stack counter control circuit (increment sc by 1 for r0+, decrement sc by 1 for r1− and decrement sc by 2 for r1−−).

When an instruction does not contain a phantom register number, the value of the SC register 206 is not modified.

The register mapping mechanism outlined above, allows all the common JVM instructions to be mapped directly into a single ARC+ machine instruction.

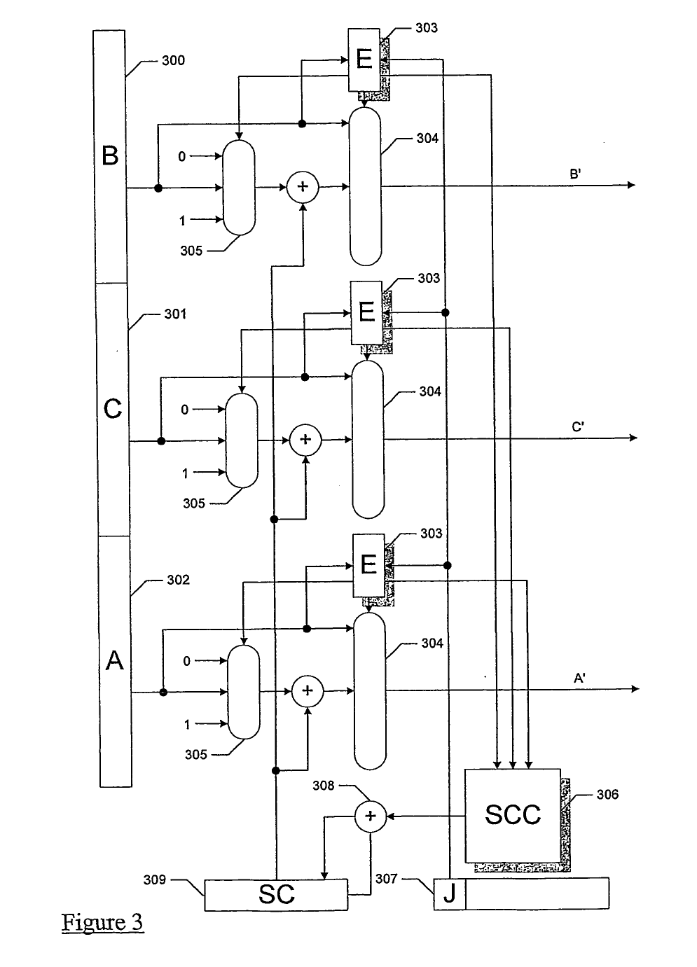

A more detailed implementation of the register mapping mechanism is shown in FIG. 3. The function of two circuits (labelled E and SCC) in the diagram can be clarified as follows. The function of circuit E 303 is to perform the actual register mapping (by generating a mux select value). Circuit E takes two inputs:

The 6 bit “original” register number.

The J bit from the status register

The E circuit generates three control signals:

The adder mux select signal (to map r0+, r1− and r1−− into r0 and r1).

A control signal into the stack counter controller to determine the value, by which sc is to be modified at the end of the cycle.

A select signal into the main mux, to determine whether the output is the same as the input (no mapping), or the mapped value.

The SCC (stack counter controller) 306 takes the stack control outputs of the three E circuits 303 and generates a constant to be added to the SC register 309 at the end of the cycle. This constant can be 0, 1, −1 or −2. It may be assumed that in a “correct” instruction, only one of the three possible operands (A, B or C) can be a phantom register number. In case of conflict, the output of the SCC 306 may be arbitrary.

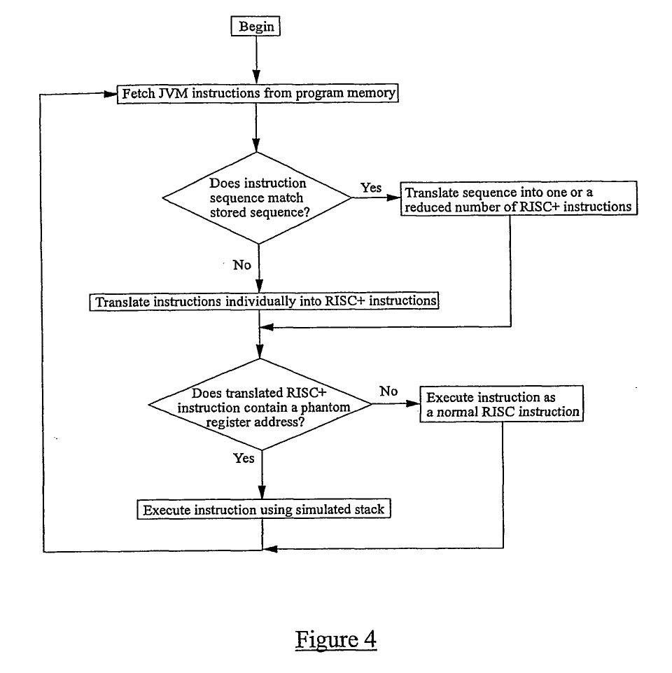

FIG. 4 is a flow diagram illustrating the method of executing a stack-based program described above.

The invention has been described with reference to a preferred embodiment. Alternatives will be apparent to persons skilled in the art. In particular, an operation different from sum (modulo the bit width of the operand field) may be utilised to perform a different mapping of the operand register number to the mapped register number. Also, different constant values from 0 and 1 may be substituted for the phantom register numbers.

The key improvement of the approach to executing stack-based instruction sets on a RISC architecture proposed here over traditional coprocessor solutions is due:

a) The fact that support for stack-oriented instructions does not require the addition of any additional pipeline stages to the RISC processor and their execution does not involve a mode switch operation and that the underlying RISC instruction set is available in addition to the augmented set in the same operating mode of the processor. The RISC instructions can be utilised to make the stack-based program much more efficient using a combination of the two translation modules (implemented either in hardware or software) described above.

b) Because no extra pipeline stages need to be added to the RISC processor, the processor's memory system, caches and pipelines do not need to be changed to support efficient execution of stack-based programs. This makes the cost of supporting stack-based execution much smaller in terms of gate-count and complexity, than a coprocessor solution.

In a modification to the embodiment of FIG. 3, the single stack counter register 309 is replaced with a pair of registers. A first of the registers maintains a pointer to the bottom element of the stack, whilst the second register which contains the number of elements currently held in the stack. The stack counter controller 306 maintains the correct values in the registers. The current stack pointer (i.e. the pointer to the top of the stack) is obtained by summing the contents of the two registers. This modification not only provides the stack pointer, but also facilitates an efficient means for removing elements from and adding elements to the bottom of the stack. Such operations are common when nested function calls are executed, and parts of the stack need to be saved to and restored from external memory.

1. A method of executing a stack-based program using a processor having a register-based architecture, the processor having means for implementing a stack using registers of the processor such that the processor may operate in a stack-based mode as well as a register-based mode, the method comprising the steps of:
fetching stack-based instructions;
translating individual stack-based instructions or sequences of stack-based instructions into register-based instructions, and including in at least certain of the translated instructions an indication that these instructions are to be executed using the stack-based mode;
executing translated instructions, including said indication, using the stack-based mode, and executing other translated instructions using the register-based mode.

2. A method according to claim 1 and comprising identifying sequences of fetched instructions which can be translated into one or a reduced number of register-based instructions and translating each identified sequence into one or a reduced number of register-based instructions, whilst translating each stack-based instruction which does not belong to one of said identified sequences into an equivalent register based instruction.

3. A method according to claim 1 or 2, wherein the translation of fetched stack-based instructions is carried prior to execution of the program and the translated program is stored in memory.

4. A method according to claim 1 or 2, wherein the translation of fetched stack-based instructions is carried out on-the-fly.

5. A method according to any one of the preceding claims, wherein the stack based-program is a JVM program, and the processor having a register-based architecture is a RISC processor such that the register-based instructions are RISC instructions.

6. A method according to any one of the preceding claims, wherein said indication that a translated instruction is to be executed using the stack-based mode is provided by the inclusion, in a register address space of the instruction, of a phantom register address.

7. A method according to claim 6, wherein, if a phantom register address is detected, that address is replaced in the instruction by an address of a register in the stack.

8. A method according to claim 6 or 7, wherein a counter register of the processor maintains a pointer to the top of the stack.

9. A method according to claim 8, wherein the detection of a phantom register address results in the alteration of the value held in the counter register.

10. A method according to any one of the preceding claims, wherein the means for implementing a stack comprises a stack counter which points to the top of the simulated stack.

11. A method according to any one of claims 1 to 9, wherein the means for implementing a stack comprises a first register pointing to the bottom of the stack, a second register maintaining the current size of the stack, and a pointer to the top of the stack is obtained by adding together the contents of the two registers.

12. Apparatus for executing a stack-based program, the apparatus comprising:
a set of registers;
means for utilising a subset of said registers to provide a stack so that the processor can operate in a stack-based mode as well as a register-based mode;
means for fetching stack-based instructions and for translating individual fetched instructions, or sequences of fetched instructions, into register-based instructions, and for including in at least certain of the translated instructions an indication that those instructions are to be executed using the stack-based mode; and
means for executing translated instructions including said indication, using the stack-based mode, and executing other translated instructions using the register-based mode.

13. Apparatus according to claim 12, wherein said indication is one of a number of phantom register addresses, and said means for utilising a subset of said registers to provide a stack comprises means for recognising a phantom register address in a translated instruction, and means for replacing that phantom address with the address of a register in the stack.

14. Apparatus according to claim 13, wherein a counter register is provided to maintain a pointer to the top of the stack, and means is provided for incrementing or decrementing the pointer held by the counter register following the processing of a translated instruction containing an indication that the instruction is to be executed using the stack-based mode.

15. Apparatus according to claim 13 and comprising a first register maintaining a pointer to the bottom of the stack, a second register maintaining the current size of the stack, and means for adding together the contents of these two registers to generate a pointer to the top of the stack.
